(19) United States
(12) Patent Application Publication
(10) Pub. No.: US 2002/0010817 A1
(43) Pub. Date: Jan. 24, 2002

(54) HOST SIGNAL PROCESSING MODEM WITH A SIGNAL PROCESSING ACCELERATOR

(76) Inventor: HAN-CHUNG YEH, SUNNYVALE, CA (US)

Correspondence Address: SKJERVEN MORRILL MACPHERSON LLP, 25 METRO DRIVE, SUITE 700, SAN JOSE, CA, 95110, US

(21) Appl. No.: 09/240,981

(22) Filed: Jan. 29, 1999

(51) Int. Cl. G06F 3/00; G06F 3/02; G06F 3/023; G06F 3/05; G06F 3/06; G06F 5/00; H04B 1/38; H04L 5/16

(52) U.S. Cl. 710/52

(57) ABSTRACT

A host signal processing accelerator and method of using the same is provided in which certain signal processing tasks which are computing intensive but are contained in short lengths of code are downloaded from the host processor to the accelerator for processing. Signal processing tasks such as FIR (finite impulse response), IIR (infinite impulse response), and FFT/IFFT (fast Fourier transform/inverse fast Fourier transform) are sent from the host processor in machine code form to a double-buffered command memory for downloading onto the system bus. The task is loaded into a command buffer located on the accelerator, and is then passed to the accelerator's signal processor for execution. The results are sent to a status buffer on the host processor.

### BACKGROUND OF THE INVENTION

1. Field of the Invention

This invention relates to communication systems that use host signal processing (HSP), in which the processor of a host computer executes procedures which implement modem functions or protocols.

2. Description of the Related Art

Host signal processing (HSP) modems use a central processing unit (CPU) in a host computer to perform digital signal processing (DSP) tasks which are normally performed by hardware in conventional modems. For example, a conventional modem receives data from a host computer, converts the data to an analog signal in compliance with a communication protocol, and transmits the analog signal on telephone lines. The conventional modem also receives an analog signal from telephone lines, extracts data from the analog signal, and transmits the data to the host computer. A DSP system in the conventional modem includes all of the software necessary for the modem's many functions. In some systems, software initially on the hard drive of the host computer is downloaded to the DSP system. performed by hardware in a conventional modem. Hardware in HSP modems performs simple analog-to-digital and digital-to-analog conversions such as converting a received analog signal to a series of digital samples that represent amplitudes of the received signal. The host computer executes software which interprets the samples according to a modem protocol and derives received data from the samples. The host computer also generates output samples that represent amplitudes of a transmitted analog signal in compliance with the modem protocol, and the hardware of the HSP modem converts the output samples into the transmitted analog signal.

Execution of HSP modem software typically occurs during periodic interrupts of the host CPU. During each such interrupt, the host CPU executes a task which reads a first block of digital samples from the modem hardware, extracts received data from the first block of samples, encodes data to be transmitted as a second block of digital samples representing an analog signal in accordance with a modem protocol, and writes the second block of digital samples to the modem hardware. Between interrupts, the modem hardware uses the second block of digital samples to maintain a continuous transmitted signal and collects a block of samples of the received signal to be read during the next interrupt.

When compared to conventional modems, HSP modems have less complex (and less expensive) hardware because HSP modems do not require dedicated signal processors. It is in part due to this feature that HSP modems have been successful in the commercial market. However, HSP modems consume part of the host computer's processing power, and the varied available computing power of different host computers is a concern for HSP modems. For example, host CPUs for traditional personal computers come in a variety of types (e.g. 486, 586, 686, Pentium, K5, and K6) which operate at a variety of clock speeds. Some computer systems may be unable to execute HSP modem processes and still provide adequate performance for other applications such as communications software which is interrupted for modem processes. In a worst case, the host CPU has insufficient available processing power for the HSP modem alone, and the HSP modem is inoperable.

For many HSP applications, the tasks which consume the most CPU processing power include finite impulse response (FIR) filters, infinite impulse response (IIR) filters, fast Fourier transforms (FFTs), and inverse fast Fourier transforms (IFFTs). Typically, the host computer executes these tasks for an HSP modem by executing a task function call inside the main program body. While the tasks themselves require relatively short lengths of code, the tasks are computationally intensive and consume significant portions of the processor's resources.

### SUMMARY OF THE INVENTION

In accordance with an aspect of the present invention, a host signal processing communication system includes an accelerator that executes tasks normally requiring significant CPU processing power. The host processor sends such tasks to the accelerator for processing in small code blocks. Signal processing tasks, such as FIR (finite impulse response) filters, IIR (infinite impulse response) filters, and FFTs/IFFTs (fast Fourier transforms/inverse fast Fourier transforms) are sent from the host processor in machine code form to a double-buffered command memory for downloading via the system bus. A task is loaded into a command buffer for the accelerator, and is then passed to the accelerator's signal processor for execution. In one embodiment, the accelerator's command buffer has memory space for a small amount of data, e.g., 1K, which allows each block of data to contain one or multiple tasks to be loaded into the command buffer. The results from the signal processing of the task are sent from a status buffer for the accelerator to a status buffer for the host processor.

### BRIEF DESCRIPTION OF THE DRAWINGS

FIG. 1 is a block diagram of a host signal processing accelerator system in accordance with the invention.

FIG. 2 is a block diagram of a second embodiment of a host signal processing accelerator system in accordance with the invention.

FIG. 3 is a flowchart illustrating operation of a host signal processing modem in accordance with the invention.

FIG. 4 is a flowchart illustrating operation of a host signal processor accelerator in accordance with the invention.

The use of the same reference symbols in different drawings indicates similar or identical items.

### DESCRIPTION OF THE PREFERRED EMBODIMENT(s)

In accordance with one embodiment of the invention, a computer system is provided with a host signal processing modem and an accelerator. The computer's CPU executes all the functions typically associated with the operation of a host signal processing modem, with the exception of certain tasks that can be efficiently delegated to the accelerator. These tasks are contained within short lengths of code that are sent over the system bus to the accelerator for execution. The results are returned back to the host system and integrated with the remainder of the modem functions.

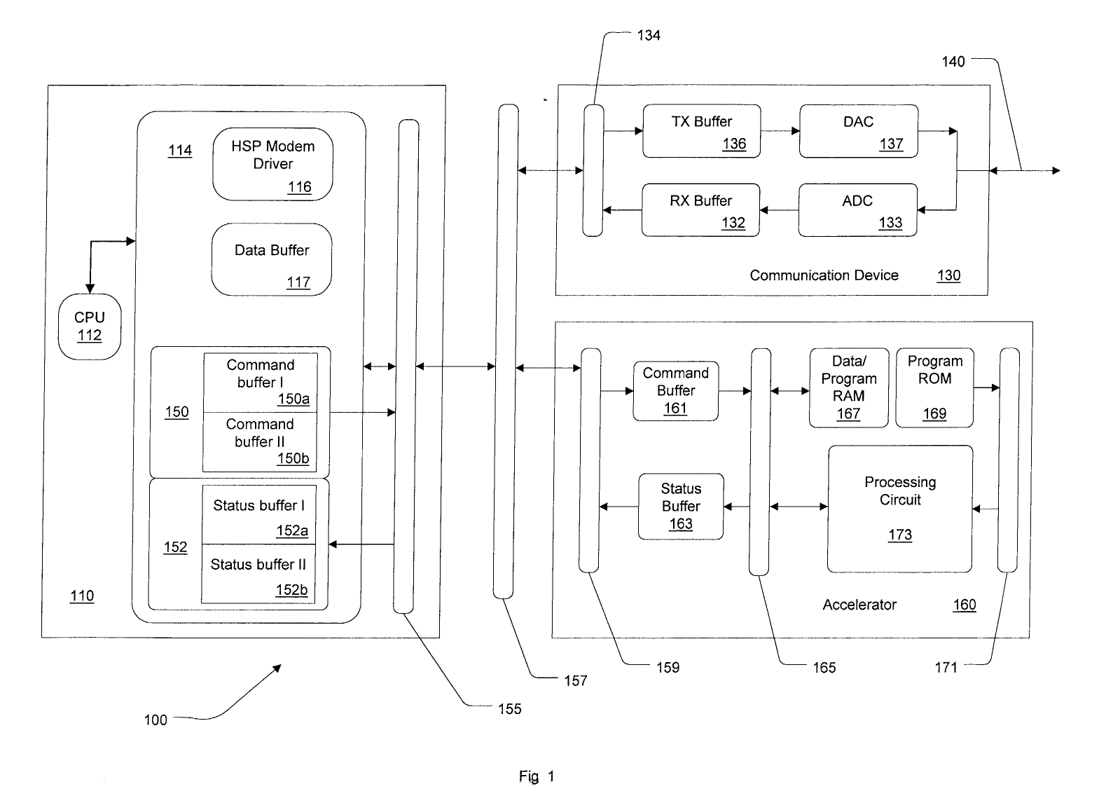

FIG. 1 shows a computer system 100 implementing an exemplary host signal processing (HSP) modem. Computer system 100 includes a host portion 110 having a CPU 112 and a memory 114 connected via a system bus interface 155 to bus 157, which is connected to a communication device 130. In an exemplary embodiment, computer system 100 is a Microsoft Windows® compatible system, and bus 157 is a local bus such as a PCI, VESA, or ISA bus. CPU 112 is a processor implementing an ×86 instruction set. Other types of processors, buses, and instructions sets may also be used.

Communication device 130 constitutes a hardware portion of the HSP modem and includes an analog-to-digital converter (ADC) 133 which converts an analog signal received on telephone line 140 into a series of digital samples which are stored in a receive (RX) buffer 132. Host computer 100 can read digital samples from RX buffer 132 via an input/output (I/O) interface 134 and can write digital samples through I/O interface 134 to a transmit (TX) buffer 136. A digital-to-analog converter (DAC) 137 converts the samples from TX buffer 136 into an analog signal which is transmitted on telephone line 140. ADC 133 and DAC 137 can be separate elements or parts of a standard codec integrated circuit. Interface 134 generates periodic interrupts that CPU 112 responds to by executing a software portion of the HSP modem. Commonly owned U.S. Pat. No. 5,721,830, entitled “Host Signal Processing Communication System that Compensates for Missed Execution of Signal Maintenance Procedures”, which is hereby incorporated by reference in its entirety, describes an exemplary embodiment of hardware for HSP modems which transfer data during periodic interrupts.

A software portion of the HSP modem includes HSP modem driver 116 which communicates with communication device 130 by reading or writing digital samples in RX buffer 132 or TX buffer 136. Such device drivers are well known in the art. Commonly owned U.S. patent application Ser. No. 08/691,063, entitled “Host Signal Processor Modem and Telephone”, filed Jul. 9, 1996, which is hereby incorporated by reference in its entirety, describes an exemplary HSP modem driver in such operating systems.

During each interrupt in a series of periodic interrupts scheduled for the HSP modem, HSP modem driver 116 reads a first block of samples from RX buffer 132, reads data to be transferred (if available) from a data buffer 117, converts the first block of samples to received data which is then written to buffer 117, and converts the data to be transmitted into a second block of digital samples which is written to TX buffer 136.

HSP modem driver 116 includes a number of tasks which implement different modem protocols or data transfer rates. These tasks may be separate software modules or one or more configurable software modules where input parameters of a configurable software module select which task the module performs when executed. Each task when executed converts samples to data and data to samples according to the protocol associated with the task. The time required for execution of any of the tasks depends on the clock frequency for operating CPU 112 and a respective count of clock cycles needed to complete the respective task. The number of clock cycles to complete a task, in turn, depends on the type of CPU 112 (e.g. whether CPU 112 is a 486, 586, 686, Pentium, K5, or K6 processor) and the amount of data represented by a block of samples.

FIG. 1 also illustrates a host signal processing accelerator system in accordance with an embodiment of the invention. Host portion 110 is connected via system bus 157 to host signal processing accelerator 160. A system bus interface 159 is provided on accelerator 160, and interface 159 enables data transfer with the system bus 157 from status buffer 163 and to command buffer 161. Data bus 165 connects processing circuit 173 and data/program RAM 167 with command buffer 161 and status buffer 163. Also provided on accelerator 160 are a program ROM 169 and a program bus 171.

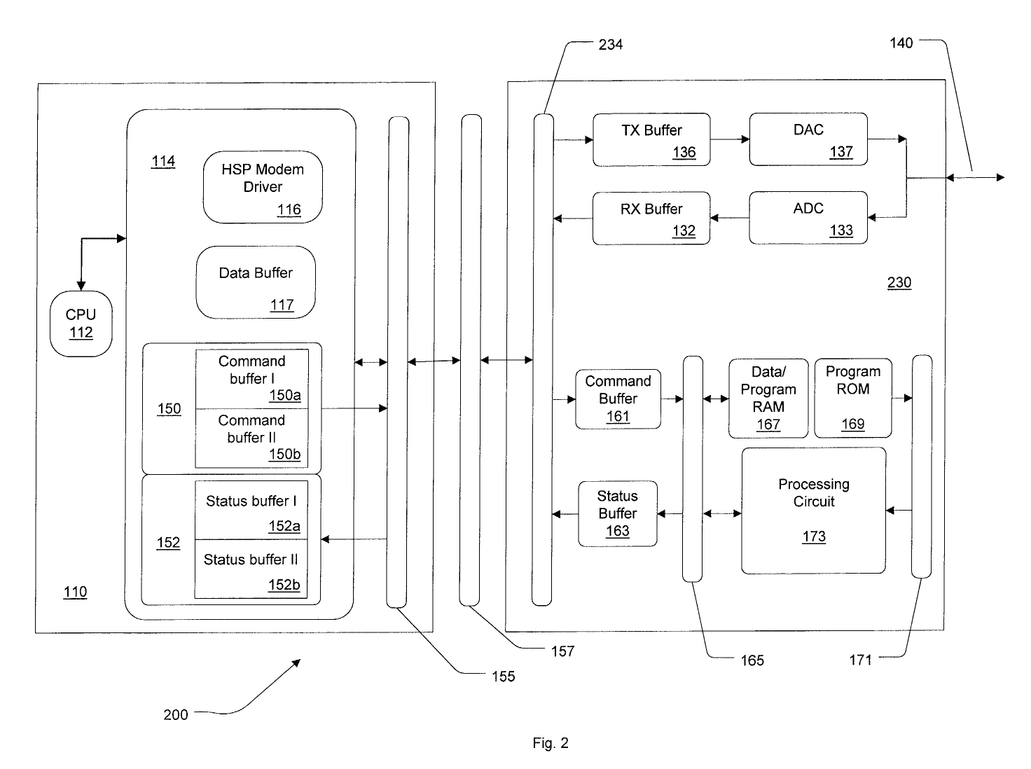

In the embodiment illustrated in FIG. 1, accelerator 160 is separate from communication device 130 and accessible for executing modem tasks and other processing. FIG. 2 illustrates an embodiment in which the components of accelerator 160 in FIG. 1 are on the same card 230 as communication device 130 in FIG. 1. In computer system 200 shown in FIG. 2, the accelerator and the hardware portion of the modem share a system bus interface 234 for transfer of information via system bus 157. Alternatively, accelerator 160 may reside on the motherboard of computer system 100 or on a different bus than communication device 130.

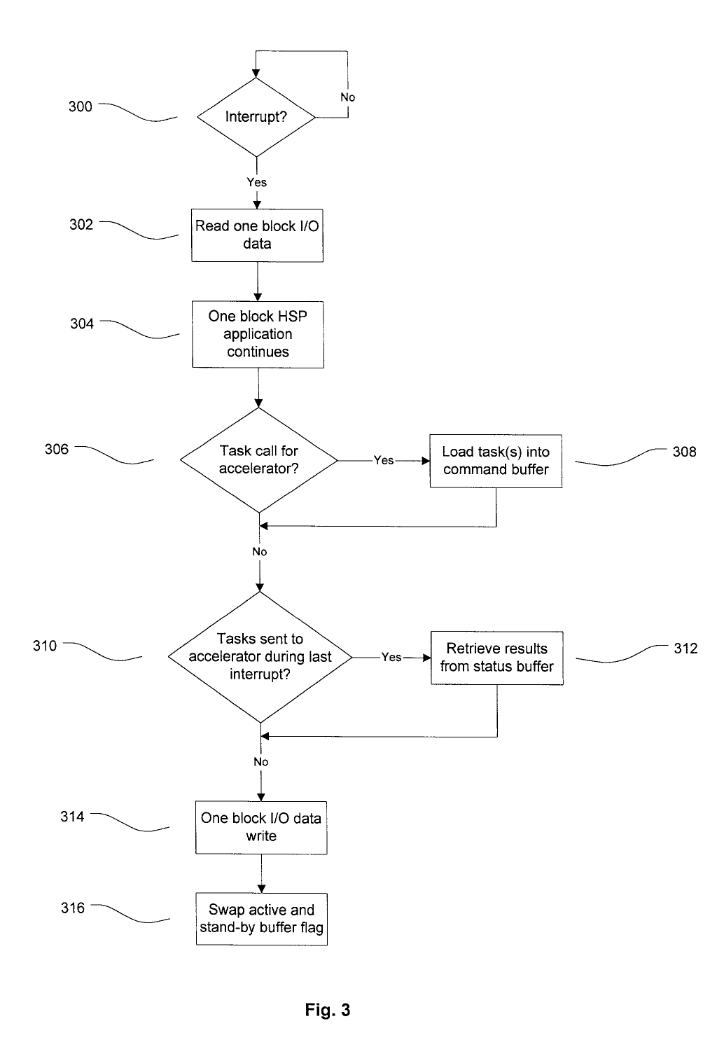

FIG. 3 illustrates a flow for the operation of a host signal processor in accordance with this invention. The execution of the HSP modem software residing in the memory 114 of host computer system 100 occurs during periodic interrupts of the host CPU 112. Beginning with step 300, host computer system 100 waits for an interrupt signal from, e.g., communication device 130. In response to each interrupt, the HSP modem software in step 302 retrieves a block of I/O data from communication device 130 for signal processing. In step 304, host CPU 112 executes signal processing tasks as in a conventional HSP method. However, certain types of tasks normally executed by the host CPU 112 are computation intensive but require processing of only small amounts of code. Examples of these types of tasks include finite impulse response (FIR) filters, infinite impulse response (IIR) filters, fast Fourier transforms (FFTs), and inverse fast Fourier transforms (IFFTs). In accordance with this invention, in step 306 when the host CPU 112 requires execution of a particular task appropriate for processing by the accelerator, such as FIR, IIR, FFT, or IFFT, CPU 112 in step 308 passes the task to the accelerator 160 for processing.

The routines required to execute these tasks involve specialized DSP functions running “looping” functions. The nature of these routines is such that the code for the routines is relatively short, so the code can be easily transmitted via system bus 157 to accelerator 160 on an “as needed” basis. Moreover, this exportation of processor-intensive tasks frees the host CPU 112 to perform other tasks.

The process for transferring the tasks is as follows. When a processing task such as FIR, IIR, FFT, or IFFT is to be executed in the program flow of the main program body, a special function task written in assembly code according to the accelerator 160's particular architecture is pushed into a stand-by command buffer. Within this task is allocated a section for the executable code and a section for the data to be processed. A protocol understood by both the CPU 112 and accelerator 160 must be used so that accelerator 160 is able to properly identify the allocated portions.

Command buffer 150 includes both command buffer I 150a and command buffer II 150b, either of which can serve as the stand-by command buffer, depending on which buffer 150a or 150b was used during the previous interrupt. Similarly for status buffer 152, either status buffer 152a or 152b may be the stand-by status buffer. A code block is written out to the stand-by status buffer, and the block may contain data for one task, or for multiple tasks, and has a size, for example, of 5K. Other embodiments may use smaller or larger code blocks.

After writing a code block to the stand-by command buffer, the main program proceeds to execute other tasks while the accelerator performs its functions. The main program also reads results from the previous code block from the stand-by status buffer, which allows CPU 112 to complete its DSP functions from the previous interrupt sequence. Although this results in a one interrupt delay, the affect on the overall performance of the system is negligible because the interrupts from communication device 130 occur at fairly frequent increments, e.g. 10 msec.

Accelerator 160 also receives the interrupt signals from communication device 130, which alerts accelerator 160 to the possible existence of new tasks in the active command buffer. Accelerator 160 then transfers the code from the active command buffer to a command buffer 161. In one embodiment, command buffer 161 is the same size as command buffers 150a and 150b, which allows command buffer 161 to transfer an entire block of data from command buffer 150 at each interrupt. Alternatively, command buffer 161 can be smaller than the active command buffer on the host portion 110, in which case command buffer 161 must load the individual tasks and the data associated with the task contained within the block of data in the active command buffer one at a time. Then, as these tasks and data are passed to processing circuit 173 for processing, the remainder of the tasks can be transferred from the active command buffer to command buffer 161. Thus, the protocol used for transferring the code block data to accelerator 160 should identify the size of each task and data associated with that task at the beginning of the task.

In step 310, if tasks were sent to accelerator 160 during the last interrupt sequence, CPU 112 in step 312 retrieves the results from status buffer 152. Then, in step 314, one block of I/O data is written out. Finally, the application in step 316 swaps the status of the active and stand-by buffer for both the command and status buffers, and will return to step 300 to wait for the next interrupt from communication device 130.

The use of multiple buffers 150a, 150b, 152a, and 152b allows the system to better deal with bus latency, and to allow time for processing by accelerator 160. These buffers 150a, 150b, 152a, and 152b create a pool that allows tasks to be continuously stored and retrieved, even if the system bus is unavailable at the time of the interrupt.

In one embodiment, the interrupt used to initiate the transfer of tasks to command buffer 161 of accelerator 160 is the same interrupt sent by communication device 130 to host portion 110 to initiate an I/O data transfer. Alternatively, the interrupt may be established by CPU 112 primarily for the use of the accelerator 160. In the Windows® environment, software can be used to create timed interrupts. This software-driven interrupt is generally not advisable for real-time DSP applications because it is typically not as accurate as the timer provided by communication device 130. However, when executing DSP simulations that do not require real-time processing, an accelerator 160 in accordance with the present invention can be used without communication device 130. Using software-driven interrupts, accelerator 160 can be used to transfer tasks to the accelerator 160 for processing.

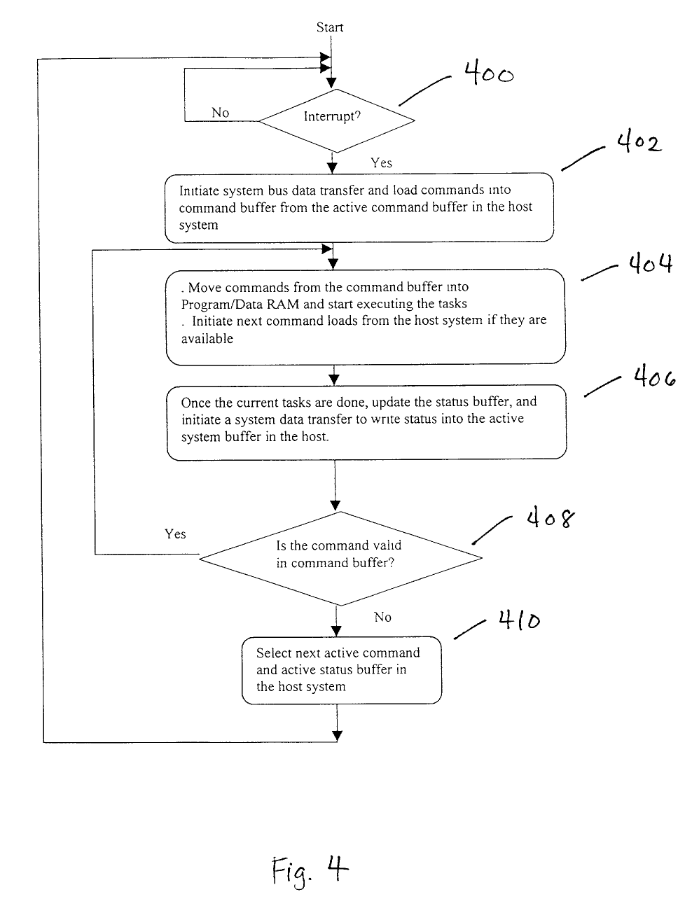

FIG. 4 illustrates the flow of the operation of accelerator 160. In step 400, accelerator 160 waits for an interrupt from communication device 130. At each interrupt, accelerator 160 initiates a data transfer to load tasks from the active command buffer on host portion 110 (either command buffer 150a or 150b) via system bus interface 155, system bus 157, and accelerator system bus interface 159 to command buffer 161 on accelerator 160, as shown in step 402. In one embodiment, command buffer 161 holds up to 1K of data. Within the 1K available space on command buffer 161, each interrupt may download the code for one task or multiple tasks. In another embodiment, command buffer 161 can store up to several hundred 16-bit words, which would limit the number or size of commands being sent to accelerator 160 for processing during each interrupt. Command buffer 161 may be any size, and the size may depend on the maximum time of system bus latency, the execution time of tasks to be processed by accelerator 160, and cost-saving considerations.

In step 404, the tasks are then moved to data/program RAM 167 via data bus 165 and are executed by accelerator processor 173 using instructions contained within the code block or retrieved from program ROM 169. In one embodiment, data/program RAM 167 holds up to 2K of data. Like command buffer 161, data/program RAM 167 can be any size but in one embodiment is optimized to minimize memory size to decrease cost and increase simplicity, while effectively processing the limited types of tasks sent from host processor 112.

Because system bus 157 is not always immediately available for data transfer, it is important to efficiently utilize system bus 157 to avoid delays caused by bus latencies. In accordance with the present invention, after a task moves from command buffer 161 to data/program RAM 167, the accelerator 160 initiates another bus transfer to load a new task from the active buffer of host command buffer 150 to command buffer 161 on accelerator 160, without waiting for the next interrupt. Alternatively, the entire block of data is transferred from the host command buffer 150 to the accelerator command buffer 161 during the regular I/O interrupts.

After processing circuit 173 completes each task, status buffer 163 is updated with the results of the execution, as shown in step 406. A system data transfer is initiated to write the status information from status buffer 163 to the active buffer on host system buffer 152. This process repeats as many times as necessary to process all tasks loaded into the host command buffer 150. In step 408, accelerator 160 checks to see if the next command in command buffer 161 is valid. When there are no more tasks to execute from the active command buffer, accelerator 160 proceeds to step 410 in which it swaps the status of the current stand-by command buffer to make it the active command buffer for the next interrupt. Accordingly, the command buffer 150 that had been the active command buffer for the last interrupt is swapped to become the stand-by command buffer for the next interrupt.

Similarly, the status buffer 152 that had been used as the active status buffer for the most recently-completed task is swapped to become the stand-by command buffer for the next interrupt, and the stand-by status buffer for the last task becomes the active status buffer.

One advantage of the present invention is that it minimizes the amount of data that must remain resident on the accelerator. Tasks such as FIR, IIR, FFT, and IFFT can be passed from the host processor to the accelerator in short lengths of code, and therefore will not overly burden the system bus. However, the exporting of these DSP tasks to an accelerator can significantly reduce the processing burden on CPU 112. Advantageously, the digital signal processor is not limited to a particular function or protocol written into the ROM of the DSP system, and also does not require large amounts of memory in order to store all of the instructions needed for signal processing. Whatever code that is required to complete the task is passed through the system bus 157 to accelerator 160 as needed. However, program ROM 169 or data/program RAM 167 may also contain code to execute accelerator tasks. Because of the small code size of the tasks transferred to accelerator 160, the code can be transferred on an as-needed basis, and it is not necessary to retain the code in memory on accelerator 160. This reduces the amount of RAM or ROM memory required for accelerator 160, and provides a greater flexibility in the types of tasks to be processed.

Although the invention has been described with reference to particular embodiments, the description is only an example of the invention's application and should not be taken as a limitation. Various adaptations and combinations of the features of the embodiments disclosed are within the scope of the invention as defined by the following claims.

I claim:

1. A process for operating a host signal processing modem, comprising:
executing a plurality of tasks on a host central processing unit;
downloading a code block to perform a particular task into an accelerator;
executing the particular task on the accelerator; and
uploading a result from the accelerator to the host central processing unit.

2. The process of claim 1, wherein the executing the particular task comprises executing a task selected from the group consisting of applying a finite impulse response filter, applying an infinite impulse response filter, performing a fast Fourier transform function, and performing an inverse fast Fourier transform function.

3. The process of claim 1, wherein said downloading comprises downloading code for the particular task into a buffer on the accelerator; and further comprising:
loading the code from the buffer to a memory provided on the accelerator; and
concurrent with executing the particular task, downloading additional code to perform a second task into the buffer on the accelerator.

4. The process of claim 1, wherein said code comprises data and executable code for processing said data.

5. A process for operating a host signal processing modem, comprising:
providing a host computer, said host computer including a central processing unit and a memory;
executing a plurality of tasks on said central processing unit;
when one of a predetermined list of tasks is to be executed:
downloading a code block for executing the one of the predetermined list of tasks to a command buffer provided on an accelerator;
executing the code block on a digital signal processor provided on the accelerator;
outputting a result from the execution of the code block to a status buffer provided on the accelerator; and
transmitting the result from the execution of the code block from the status buffer to the memory of the host computer.

6. The process of claim 5, wherein the predetermined list of tasks includes at least one of the group consisting of a finite impulse response filter, an infinite impulse response filter, a fast Fourier transform function, and an inverse fast Fourier transform function.

7. The process of claim 5, further comprising, concurrent with the executing the code block, downloading additional code for executing another of the predetermined list of tasks to the command buffer provided on the accelerator.

8. The process of claim 5, wherein said code block comprises data and executable code for processing said data.

9. A host signal processing accelerator, comprising:
a system bus interface;
a command buffer for receiving a code block from a host computer via the system bus interface;
a status buffer for transmitting a result to the host computer via the system bus interface; and
a digital signal processor for receiving the code block from the command buffer, executing a task corresponding to the code block, and outputting the result to the status buffer.

10. The host signal processing accelerator of claim 9, further comprising a data bus for transmitting the code block from the command buffer to the digital signal processor and for transmitting the result from the digital signal processor to the status buffer.

11. The host signal processing accelerator of claim 9, wherein said digital signal processor comprises:
a data/program random access memory;
a program read-only memory; and
a processor.

12. The host signal processing accelerator of claim 9, wherein said data/program random access memory is less than about 5 K.

13. The host signal processing accelerator of claim 10, wherein said data/program random access memory is about 2 K.

14. The host signal processing accelerator of claim 10, wherein said program read-only memory is less than about 1 K.

15. The host signal processing accelerator of claim 10, wherein said program read-only memory is about 0.5 K.

16. A process for operating a host signal processing modem, comprising:
executing a plurality of tasks on a central processing unit on a host portion of a computer;
forming a code block comprising at least one task and data corresponding to each of said at least one tasks;
downloading said code block to an accelerator;
executing each of said at least one tasks on said accelerator; and
uploading the results from the execution of each task to a memory on the host portion of the computer; and
processing said results on said host central processing unit.

17. The process of claim 16, wherein each task in said code block is a task selected from the group consisting of applying a finite impulse response filter, applying an infinite impulse response filter, performing a fast Fourier transform function, and performing an inverse fast Fourier transform function.

18. The process of claim 16, wherein:
said forming a code block comprises forming a code block and downloading the code block into a first buffer on the host portion of the computer;
said downloading said code block to the accelerator comprises loading from the first buffer at least one task and the data corresponding to the task onto a second buffer provided on the accelerator; and
concurrent with executing the task on said accelerator, downloading from said code block on the first buffer a second task and data corresponding to the second task into the second buffer.
